(19) United States
(12) Patent Application Publication
(10) Pub. No.: US 2026/0133733 A1
(43) Pub. Date: May 14, 2026

(54) INFORMATION PROCESSING APPARATUS, CONTROL METHOD, AND STORAGE MEDIUM

(71) Applicant: CANON KABUSHIKI KAISHA, Tokyo (JP)

(72) Inventor: YOICHIRO SHIBUYA, Saitama (JP)

(21) Appl. No.: 19/374,413

(22) Filed: Oct. 30, 2025

(30) Foreign Application Priority Data
Nov. 12, 2024 (JP) 2024-197637

(51) Int. Cl. G06F 3/12; B41J 11/00; G06T 11/60

(52) U.S. Cl. CPC G06F 3/1253; B41J 11/0065; G06F 3/1205; G06F 3/1232; G06F 3/1287; G06T 11/60

(57) ABSTRACT

A non-transitory computer-readable storage medium storing an application program which causes an information processing apparatus to perform a control method, the application program cooperating with an Internet Printing Protocol (IPP) class driver, the control method includes displaying, as first displaying, a first object capable of setting a setting value relating to borderless printing, and displaying, as second displaying, in a case where borderless printing is set to be performed by using the first object, an image indicating data to be printed and information for indicating a range, within the data to be printed, that is to be printed on a sheet by performing borderless printing.

### BACKGROUND

### Field of the Technology

The present disclosure relates to an information processing apparatus, a control method, and a storage medium.

### Description of the Related Art

A configuration has been known that issues print instructions to a printing apparatus connected to a host computer using a printer driver that is installed on the host computer as printing apparatus control software. An operating system (OS) that is basic software is installed on the host computer, and the printer driver is configured in compliance with specifications defined by the OS and operate when called by the OS. Vendors that provide printing apparatuses can provide means for instructing their printing apparatuses to print using the OS by providing printer drivers compatible with the OS specifications.

In recent years, Windows (registered trademark) has provided standard class drivers (hereinafter, also referred to as "standard drivers") that can be used with printing apparatuses provided by multiple vendors in common. Such standard drivers are bundled in the OS packages and become readily usable by connecting any printing apparatus to the host computer. This is highly convenient because model-specific printer drivers suited to printing apparatuses do not need to be installed separately.

Standard drivers are configured so that print functions can be specified based on PrintCapabilities generated from information acquired from the connected printing apparatus. This enables users who use a standard driver to specify print functions based on the capabilities of connected printing apparatuses despite the use of a single standard driver.

Standard drivers can be associated with applications for function extension (hereinafter, referred to as "extension applications"). Extension applications can be provided by vendors that provide printing apparatuses. Extension applications can provide functions (extended functions) that cannot be implemented with the standard drivers alone by editing PrintDeviceCapabilities (PDC) generated by the standard driver.

Japanese Patent Laid-Open No. 2019-74906 describes a technique for providing a graphical user interface (GUI) such as one displaying a print preview screen, using an extension application. Even when using the standard driver and extension application, users can know what the print result will look like before the printing apparatus prints by the extension application displaying a print preview screen.

However, when the extension application described in Japanese Patent Laid-Open No. 2019-74906 is used, the print result displayed on the print preview screen and the print result actually printed by the printing apparatus may differ in appearance.

For example, when performing borderless printing, the printing apparatus implements the borderless printing by intentionally enlarging an image so that the image exceeds a predetermined printing area on the sheet. Meanwhile, the print preview screen may inadvertently display the image including even the areas that exceed the sheet and will not be printed, because the processing performed by the printing apparatus is not taken into account. From the user's perspective, despite the advance check of what the print result will look like on the print preview screen, the actual print result can differ, which potentially leads to misprints in some cases.

### SUMMARY

According to an aspect of the present disclosure, a non-transitory computer-readable storage medium storing an application program which causes an information processing apparatus to perform a control method, the application program cooperating with an Internet Printing Protocol (IPP) class driver, the control method includes displaying, as first displaying, a first object capable of setting a setting value relating to borderless printing, and displaying, as second displaying, in a case where borderless printing is set to be performed by using the first object, an image indicating data to be printed and information for indicating a range, within the data to be printed, that is to be printed on a sheet by performing borderless printing.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a hardware configuration of a printing system.

FIGS. 2A and 2B are configuration diagrams of the printing system according to a first embodiment.

FIG. 3 is a flowchart for adding a borderless printing function to print function information (PrintDeviceCapabilities [PDC]).

FIG. 4 illustrates an example of a sheet information list for a printing apparatus to return using media-col-database.

FIGS. 5A to 5C illustrate examples of a print setting screen displayed by a print setting screen extension unit.

FIG. 6 illustrates an example of PrintTicket where borderless printing and print preview are selected.

FIG. 7 is a sequence diagram where a print data editing unit launches a print data editing unit user interface (UI) display unit.

FIGS. 8A and 8B are flowcharts of processing for the print data editing unit UI display unit to generate a print preview image during borderless printing.

FIG. 9 illustrates an example of borderless bleed amounts of a printing apparatus.

FIGS. 10A to 10C illustrate examples of a print preview screen displayed by the print data editing unit UI display unit.

FIGS. 11A and 11B are a flowchart of processing for the print data editing unit UI display unit to generate a print preview image when a function related to 180-degree (º) image rotation is selected.

FIGS. 12A and 12B illustrate examples of a print preview screen displayed by the print data editing unit UI display unit when 180º image rotation is selected.

FIG. 13 is a sequence diagram for the print data editing unit and the print data editing unit UI display unit when borderless bleed amounts are set.

FIGS. 14A and 14B illustrate examples of a print preview screen displayed by the print data editing unit UI display unit, where borderless bleed amounts can be set.

### DESCRIPTION OF THE EMBODIMENTS

Hereinafter, a desirable embodiment of the present disclosure will be described in detail with reference to the accompanying drawings. The following embodiment does not limit the scope of the present disclosure as defined by the claims, and not all combinations of features described in the embodiment are necessarily essential to the solutions provided by the present disclosure.

Similar components are denoted by the same reference numerals, and the redundant descriptions are omitted.

### First Embodiment

### Hardware Configuration of Printing System

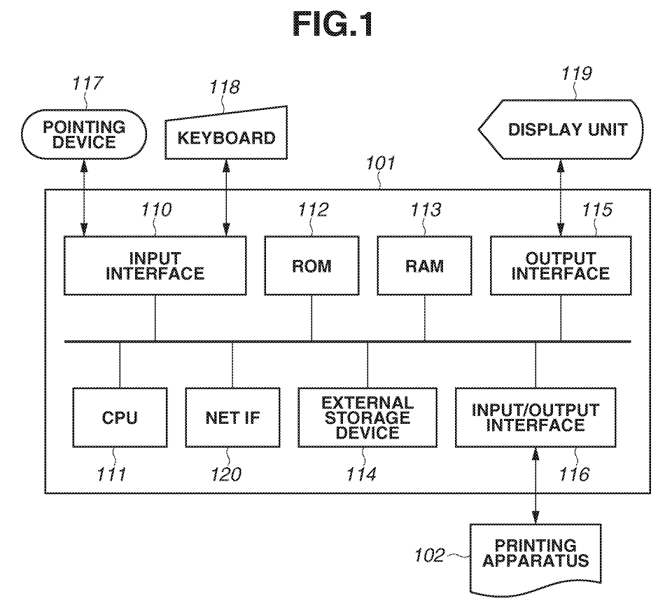

FIG. 1 is a block diagram illustrating a hardware configuration of a printing system. In this diagram, a host computer 101 is an example of an information processing apparatus, and includes an input interface 110, a central processing unit (CPU) 111, a read-only memory (ROM) 112, a random-access memory (RAM) 113, an external storage device 114, an output interface 115, and an input/output interface 116.

Input devices such as a keyboard 118 and a pointing device 117 are connected to the input interface 110. A display device such as a display unit 119 is connected to the output interface 115.

A network interface (NET IF) 120 controls data transfer to/from external devices via a network.

The ROM 112 stores an initialization program. The external storage device 114 stores application programs, an operating system (OS), print data generation software, and various other types of data. The RAM 113 is used as a work memory and the like in executing various programs stored in the external storage device 114, whereby various programs can run on the host computer 101.

In the present embodiment, the CPU 111 performs processing based on the procedures of the programs stored in the ROM 112, whereby functions of the host computer 101 to be described below and processing related to flowcharts to be described below are executed. A printing apparatus 102 that is a device is connected to the host computer 101 via the input/output interface 116.

While the host computer 101 and the printing apparatus 102 here are separately configured, the two may be configured as a single information processing apparatus. The printing apparatus 102 will be described by using an inkjet printer that prints by discharging ink to a sheet surface as an example. However, printing may be performed by other methods (for example, electrophotography). The host computer 101 may be a desktop personal computer, a smartphone, or a laptop personal computer.

### Software-Centered Configurations of Printing System

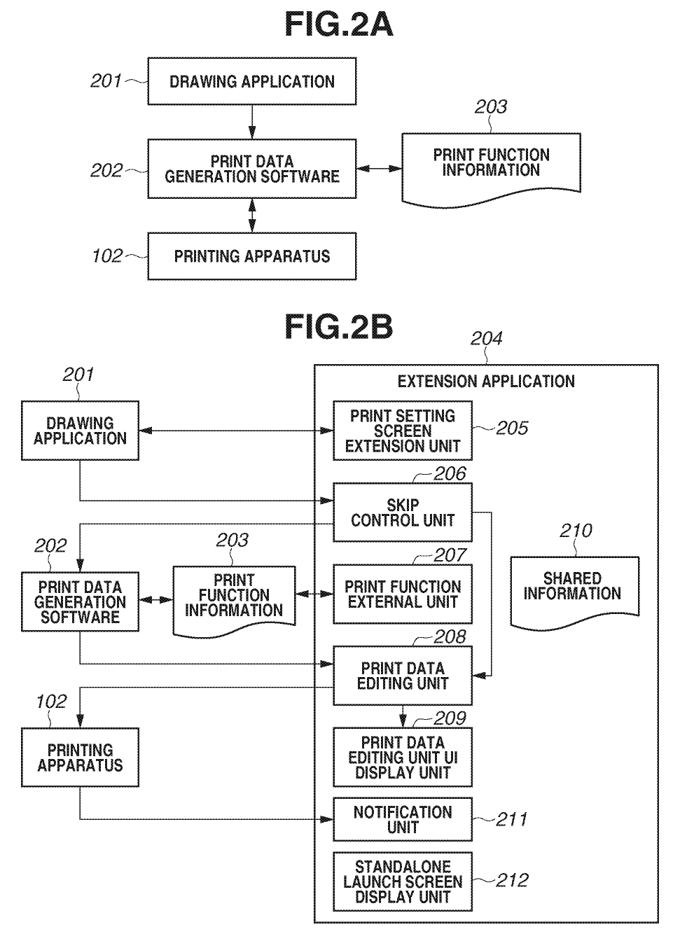

FIGS. 2A and 2B are diagrams schematically illustrating software-centered configurations of the printing system. The following description uses a case of a printing system that uses a host computer 101 equipped with Microsoft (registered trademark) Windows (registered trademark) as the OS. FIG. 2A is a diagram illustrating a typical configuration where an extension application 204 is not associated with print data generation software 202 or the printing apparatus 102.

A drawing application 201 is software for generating content to be printed (drawing data). Examples include word processing applications and spreadsheet applications. When receiving a print request from the user, the drawing application 201 issues print instructions to the OS. The print instructions include print setting information for giving instructions about the operation of the print data generation software 202 and the printing apparatus 102. The print setting information is also referred to as PrintTicket (PT).

To output the print setting information, the drawing application 201 can display a print setting screen provided by one of the print data generation software 202, OS, and drawing application 201. The print setting screen includes objects (hereinafter, referred to as "control items") representing available print functions and control items indicating the setting values thereof based on capability information (information configurable as print settings) acquired from the print data generation software 202. The capability information is also referred to as PrintCapabilities (PC).

The print data generation software 202 determines PC based on print function information 203. The print function information 203 is data that describes all settable print functions and their setting values, as well as print functions with exclusive relationships between their setting values defined. The print function information 203 is also referred to as PrintDeviceCapabilities (PDC).

The PDC 203 is included in a configuration file of the print data generation software 202 and deployed to the external storage device 114 as an unmodifiable file. Alternatively, the PDC 203 may be dynamically generated by the print data generation software 202. In this case, the PDC 203 generated is editable. Specifically, the print data generation software 202 or the OS can be configured to acquire attribute data on the printing apparatus 102 from the printing apparatus 102 and generate the PDC 203 based on attribute information in the acquired attribute data.

The attribute data on the printing apparatus 102 is acquired by issuing an Internet Printing Protocol (IPP) Get-Printer-Attributes operation to the printing apparatus 102. A response to the Get-Printer-Attributes operation includes attribute information indicating the functions of the printing apparatus 102 that can be specified (capabilities of the printing apparatuses 102) and setting values associated with the attribute information. The response is stored in the RAM 113.

With such a configuration, the print data generation software 202 can be configured so that users can specify print functions usable on connected printing apparatuses 102 based on the respective printing apparatuses 102. In other words, the print data generation software 202 can be configured so that even when printing apparatuses 102 with different functions or printing apparatuses 102 developed by different vendors are connected, users can specify usable print functions based on the printing apparatuses 102 connected.

Now, a configuration using an IPP class driver or a Universal Print (UP) class driver included in Windows (registered trademark) as the print data generation software 202 will be described.

The IPP class driver and the UP class driver are printer drivers for performing print processing in compliance with the standard print protocol called IPP, and bundled in the OS package.

The IPP class driver and the UP class driver are not printer drivers specific to a model of printing apparatus 102, but standard class drivers capable of transmitting print data to a plurality of different printing apparatuses provided by a plurality of different manufacturers. The IPP class driver is a standard driver for performing local printing in compliance with the foregoing specifications, and the UP class driver is a standard driver for performing cloud printing.

When cloud printing is performed using the UP class driver, the print data is not directly transmitted to the printing apparatus 102 but transmitted via cloud printing-related services and printed by the printing apparatus 102. The IPP class driver and the UP class driver acquire the capability information about the connected printing apparatus 102 and generate the print function information 203 based on the acquired information so that the user can specify print functions supported by the connected printing apparatus 102.

The OS generates intermediate data (also referred to as input data) based on the print instructions output from the drawing application 201 and passes the intermediate data to the print data generation software 202. The data that the drawing application 201 outputs for printing is data in Graphics Device Interface (GDI) format or Extensible Markup Language (XML) Paper Specification (XPS) format.

When the print data generation software 202 is used and the data output by the drawing application 201 is data in GDI format, the OS converts the data in GDI format output from the drawing application 201 into data in XPS format. The OS then passes the converted data in XPS format to the print data generation software 202 as intermediate data. When the data output by the drawing application 201 is data in XPS format, the OS passes the data in XPS format to the print data generation software 202 as intermediate data.

The intermediate data includes drawing data that is information about images to be formed on sheets, and the print setting information set by the user.

The print data generation software 202 converts the acquired intermediate data into print data interpretable by the printing apparatus 102 and transmits the print data to the printing apparatus 102. The print data includes the drawing data that is the information about the images to be formed on sheets, and print setting attribute information (attribute information for specifying print settings) generated based on the print setting information set by the user. The print setting attribute information includes attribute information indicating the functions of the printing apparatus 102 that can be specified (capabilities of the printing apparatus 102) and setting values associated with the attribute information.

The printing apparatus 102 performs printing on sheets based on the print data transmitted from the print data generation software 202. Here, the printing apparatus 102 forms the drawing data included in the print data on sheets through operations based on the print setting attribute information included in the print data. The print setting attribute information includes attribute information for specifying print quality (such as image quality priority and speed priority), two-sided printing, and the like, and their setting values. For example, when the print setting attribute information includes attribute information for specifying two-sided printing, the printing apparatus 102 performs two-sided printing.

FIG. 2B is a diagram illustrating a configuration when the extension application 204 is associated with the print data generation software 202 and the printing apparatus 102. Components and processes not mentioned in particular below are similar to those of FIG. 2A.

The extension application 204 is software for extending the functions of the print data generation software 202 and not included (not bundled) with the OS by default. The user therefore needs to operate the host computer 101 to download the extension application 204 from a server via the Internet and install the extension application 204.

Alternatively, the extension application 204 may be automatically installed based on connection of the printing apparatus 102 to the host computer 101. Specifically, when the printing apparatus 102 is connected to the host computer 101, the OS acquires device identification information from the printing apparatus 102. The OS may download the extension application 204 corresponding to the acquired device identification information from the server via the Internet and install the extension application 204. In other words, the print data generation software 202 and the extension application 204 are stored in the host computer 101 as separate files.

The print data generation software 202 and the extension application 204 may be updated for upgrade, and the update processes are performed at different times. More specifically, the timing when the host computer 101 acquires the print data generation software 202 differs from the timing when the host computer 101 acquires the extension application 204. The trigger for the host computer 101 to acquire the print data generation software 202 also differs from the trigger for the host computer 101 to acquire the extension application 204.

When the extension application 204 is installed, the OS associates the extension application 204 with the print data generation software 202 and the printing apparatus 102.

The extension application 204 described in the present embodiment includes a print setting screen extension unit 205, a skip control unit 206, a print function extension unit 207, a print data editing unit 208, a notification unit 211, and a print data editing unit user interface (UI) display unit 209. The extension application 204 includes shared information 210 that can be accessed by these units in common. The actual entity of the shared information 210 is a file stored in the external storage device 114 or information stored in the RAM 113.

The extension application 204 can freely write and read information to/from the shared information 210 using application program interfaces (APIs) provided by the OS. The shared information 210 is allocated as an area where application-specific information can be stored, and can also store information other than the attribute data on the printing apparatus 102.

The shared information 210 is information different from the PDC 203 that is generated by the print data generation software 202 or the OS for the sake of specifying usable print functions of the connected printing apparatus 102.

The extension application 204 may be terminated each time the processing of each unit is completed. In such a case, the OS launches the extension application 204 each time a request to use one of the units is received. Other configurations are also conceivable. For example, the OS may terminate the extension application 204 when the processing of the print setting screen extension unit 205 is completed, and keep the extension application 204 running when the processing of the skip control unit 206 is completed.

Moreover, the extension application 204 may cancel processing of each unit partway through. Upon cancellation, the OS deletes the job in process in the print queue.

When receiving a print request from the user, the drawing application 201 issues print instructions to the OS. In this configuration, like the configuration of FIG. 2A, the drawing application 201 can display a print setting screen. In this configuration, the drawing application 201 displays a print setting screen provided by the extension application 204. Specifically, a print setting screen provided by the print setting screen extension unit 205 included in the extension application 204 is displayed.

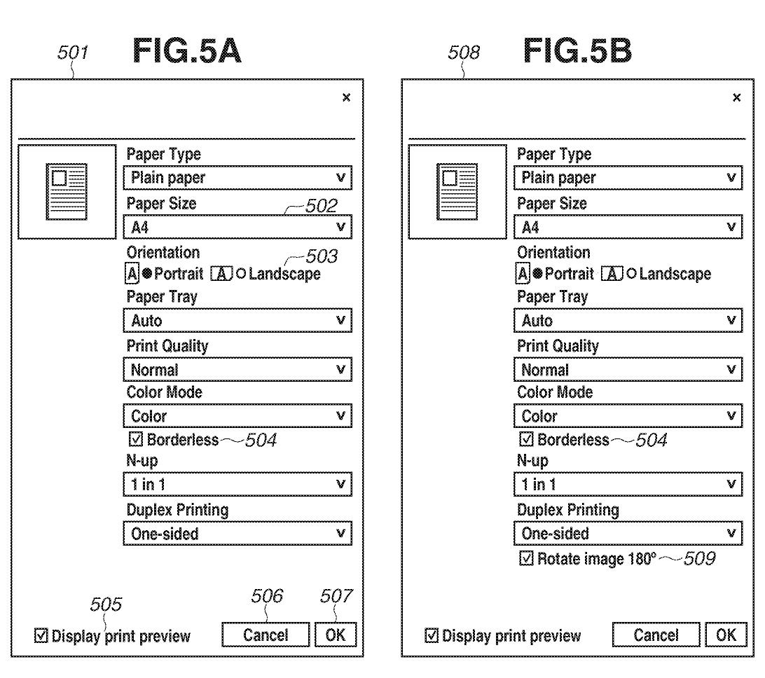

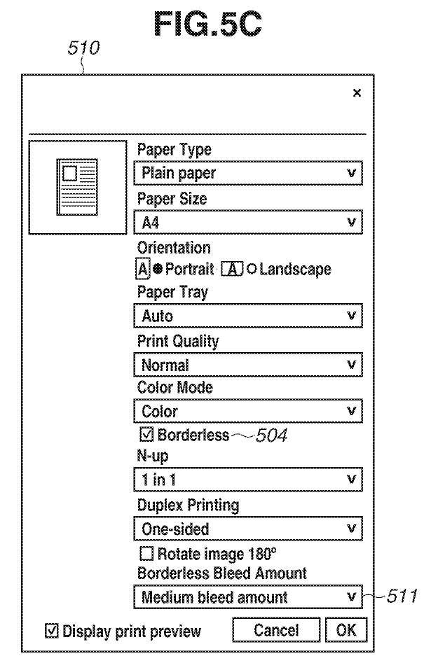

Whether to display the print setting screen provided by the print setting screen extension unit 205 depends on user operation. A case where the drawing application 201 is a word processing application or spreadsheet application will be described as an example. In such a case, the print setting screen provided by the print setting screen extension unit 205 is displayed when the user presses a property setting button displayed on a print setting screen provided by the word processing application or spreadsheet application. Details of the print setting screen extension unit 205 will be described below with reference to FIGS. 5A to 5C.

When the drawing application 201 accepts the print request from the user and print instructions are issued to the OS, the OS launches the skip control unit 206. The skip control unit 206 controls whether to skip the processing of the print data generation software 202. The skip control unit 206 is not capable of acquiring intermediate data or print setting information. After the skip control processing of the skip control unit 206, the OS generates intermediate data based on the print instructions output from the drawing application 201 and passes the intermediate data to the print data generation software 202.

In a case where the skip control unit 206 does not perform the skip control, the print data generation software 202 processes the intermediate data into print data interpretable by the printing apparatus 102 and passes the print data to the print data editing unit 208.

On the other hand, in a case where the print data generation software 202 is skipped, the intermediate data is not processed by the print data generation software 202 but passed to the print data editing unit 208. This enables processing of the intermediate data by the print data editing unit 208.

Examples of the case where the print data generation software 202 can be skipped include when the user wants to perform enlargement/reduction processing using the print data editing unit 208. The intermediate data can retain data in a vector format, with little degradation when enlarged or reduced. In a configuration where the print data generation software 202 outputs images in a raster format, the processing of the print data generation software 202 can typically be skipped so that the intermediate data is processed by the print data editing unit 208.

The print data editing unit 208 edits the intermediate data passed from the print data generation software 202 or the print data processed by the print data generation software 202. Take N-up printing as an example of the editing operation. The print data editing unit 208 changes the layout of the intermediate data or print data based on print setting information about N-up printing received from the OS.

The print data editing unit 208 can request the OS to display a UI screen on the display unit 119. Based on the request from the print data editing unit 208, the OS launches the print data editing unit UI display unit 209. For example, the print data editing unit UI display unit 209 can display the layout result of the intermediate data or print data on the display unit 119 as a preview screen.

With the UI screen kept open by the print data editing unit UI display unit 209, the print data editing unit 208 does not transmit the print data to the printing apparatus 102. Once the UI screen displayed by the print data editing unit UI display unit 209 is closed, the print data editing unit 208 performs processing for transmitting the print data.

After the editing of the print data by the print data editing unit 208, the print data is passed to the printing apparatus 102 via the OS. The printing apparatus 102 performs printing on sheets based on the print data accepted. In a case where the print data generation software 202 is skipped by the skip control unit 206, the print data editing unit 208 may convert the received intermediate data into print data interpretable by the printing apparatus 102. To convert the intermediate data into print data, the print data editing unit 208 may use functions provided by the OS.

The extension application 204 includes the print function extension unit 207. The print function extension unit 207 can edit the PDC 203 generated by the print data generation software 202 or the OS. The print function extension unit 207 can thereby add functions provided by the extension application 204, add functions that are supported by the printing apparatus 102 but not supported by the print data generation software 202, etc. Exclusive relationships between setting values of print functions can also be added, among other things.

The OS launches the print function extension unit 207 when the extension application 204 is first associated with the printing apparatus 102 and the print data generation software 202. The OS may further launch the print function extension unit 207 at other timings, such as when the OS starts up. This enables the print function extension unit 207 to detect and add extended functions to the PDC 203 in cases such as where optional devices (such as finishers) are added to the printing apparatus 102 afterward and the print-related functions are extended.

The extension application 204 includes the notification unit 211. The notification unit 211 can display user notifications in response to the occurrence of errors in the printing apparatus 102.

For example, when a paper-out error occurs in the printing apparatus 102, the print data generation software 202 detects the paper-out error, and the OS displays a message on the display unit 119 using a notification function called toast notification, which is an OS function. When the user presses this toast notification, the notification unit 211 of the extension application 204 is called by the OS, and an UI screen of the notification unit 211 is displayed. The UI screen of the notification unit 211 can display a detailed message about the paper-out error, a sheet loading method, and the like, for example.

The extension application 204 includes a standalone launch screen display unit 212. The extension application 204 operates in association with the print data generation software 202, whereas the extension application 204 can also operate by itself. When the user issues a launch instruction for the extension application 204, the standalone launch screen display unit 212 of the extension application 204 is called, and a UI screen of the standalone launch screen display unit 212 is displayed.

Once the print data is transmitted to the printing apparatus 102, the extension application 204 can no longer provide screen display such as guides associated with the print data during the processing of each unit.

The extension application 204 for implementing the present embodiment is not limited to the configuration including all the foregoing functions (units). The extension application 204 may be configured to include a subset of the functions or include other functions. The extension application 204 may be referred to simply as print software. As described above, the extension application 204 can be said to include at least one of the units 205 to 209 and 211.

Addition of Borderless Printing Function to Print Function Information by Print Function Extension Unit

The present disclosure is directed to providing a technique for displaying an accurate print result on a print preview screen even when applications supporting standard drivers such as the IPP class driver are used.

Among inkjet printers and laser beam printers are printing apparatuses that can perform borderless printing. Borderless printing is a function of arranging and printing an image so that no margins appear on the sheet printed by the printing apparatus. In other words, when a printing apparatus prints normally, image data included in the print data is arranged on the sheet to allow for a predetermined margin from the sheet edges during printing. By contrast, in borderless printing, the predetermined margin from the sheet edges is set to 0 so that printing is performed without any margin.

Moreover, in a case where a borderless bleed amount is specified for the printing apparatus, the printing apparatus prints with a negative margin so that ink is discharged beyond the sheet edges. Such control enables borderless printing regardless of the conveyance accuracy of each printing apparatus.

While borderless printing is a function that can be used with vendor-specific printer drivers, there are known cases of implementation where the host computer 101 generates image data enlarged beyond the sheet size in advance and transmits the print data to the imaging apparatus for printing.

On the other hand, in the case of performing borderless printing with the print data generation software 202 and the extension application 204 using the IPP protocol, the printing apparatus 102 prints the received image data with a negative margin as much as a predetermined borderless bleed amount. In other words, the printing apparatus 102 implements borderless printing by enlarging the received image by the borderless bleed amount and printing the enlarged image.

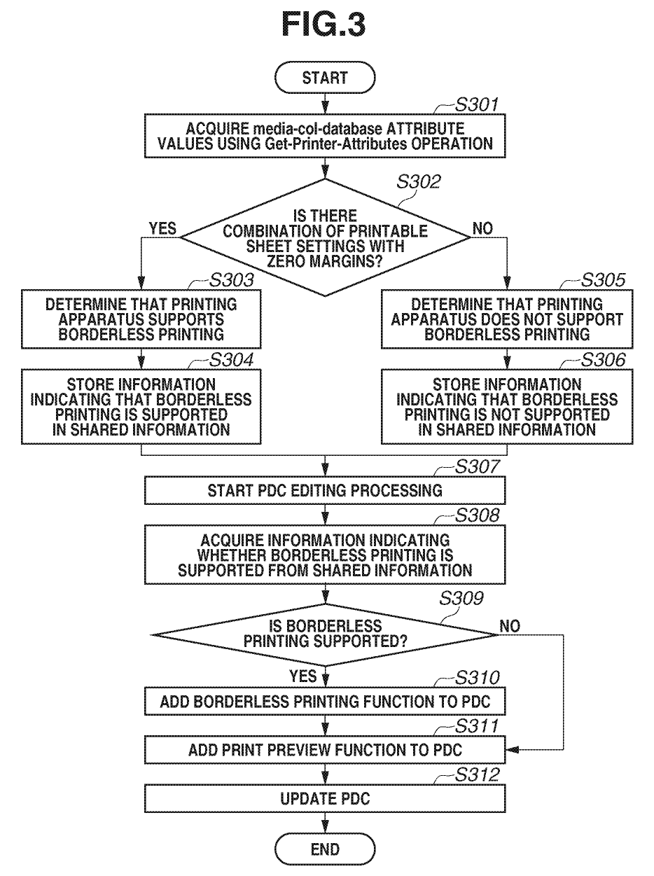

A procedure for the print function extension unit 207 of the extension application 204 to add a borderless printing function to the print function information 203 will be described with reference to FIG. 3.

The processing procedure of FIG. 3 starts when a print queue associated with the extension application 204 is selected by the user and one of the units included in the extension application 204 is launched. Alternatively, the OS may directly launch the extension application 204 regardless of whether the user launches the extension application 204.

In step S301, the print function extension unit 207 of the extension application 204 acquires capability information from the printing apparatus 102. The capability information is acquired as a response from the printing apparatus 102 by the print function extension unit 207 issuing an IPP Get-Printer-Attributes operation to the printing apparatus 102.

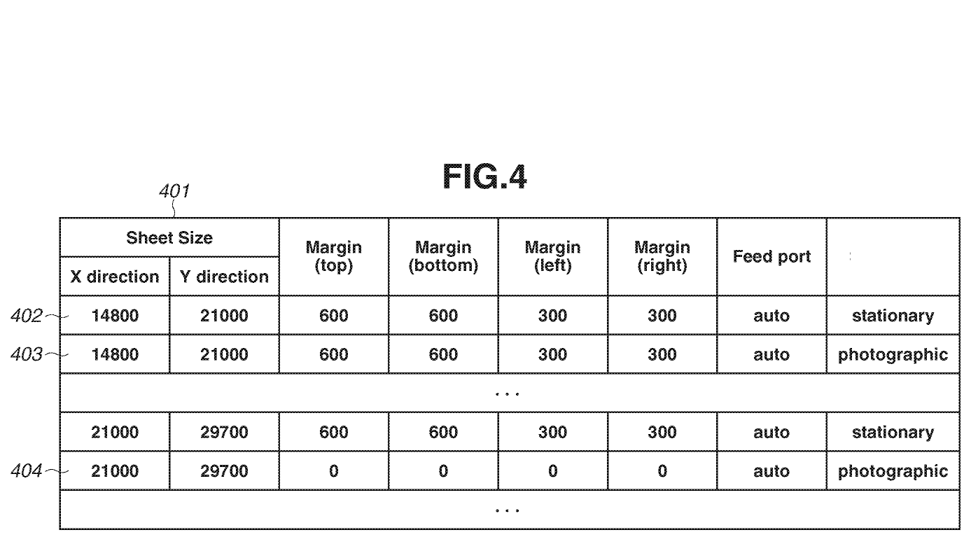

There are multiple pieces of attribute data that can be acquired as a response from the printing apparatus 102. In the present embodiment, media-col-database attribute values are acquired. The media-col-database attribute values describe detailed information about sheet settings printable by the printing apparatus 102. An example of information that the printing apparatus 102 returns using the media-col-database attribute will be described with reference to FIG. 4.

FIG. 4 illustrates a sheet information list 401, which is a schematic representation in list form of part of attribute data related to printable sheet information that the printing apparatus 102 returns using the media-col-database attribute. The sheet information list 401 expresses pieces of information with a sheet size in an X direction, a sheet size in a Y direction, top, bottom, left, and right margin sizes of a sheet, a feed port where the sheets can be set, and a sheet type as a set. As employed herein, the top margin falls on the leading side in the sheet conveyance direction of the printing apparatus 102.

A specific description will be given with reference to row 402 of the sheet information list 401. In the present embodiment, size information is expressed in units of 1/100 mm.

Row 402 contains sheet information representing one of combinations of sheet settings printable by the printing apparatus 102. Specifically, row 402 indicates that the sheet size is 14800 in width and 21000 in height, and the top, bottom, left, and right margins with respect to the sheet size are 600, 600, 300, and 300, respectively. The feed port is "auto" and the sheet type is "stationary". This information indicates that the above combination of sheet settings is printable by the printing apparatus 102.

Similarly, row 403 indicates that the sheet size is 14800 in width × 21000 in height, and the top, bottom, left, and right margins with respect to the sheet size are 600, 600, 300, and 300, respectively. The feed port is "auto" and the sheet type is "photographic". This sheet information indicates that the above combination of sheet settings is printable by the printing apparatus 102. The combinations of printable sheet settings described in rows 402 and 403 can be said to be examples of combinations of sheet settings indicating that bordered printing can be performed, since there are margins on four sides of the sheets.

Meanwhile, row 404 indicates that the sheet size is 21000 in width × 29700 in height, and the top, bottom, left, and right margins with respect to the sheet size are 0, 0, 0, and 0, respectively. The feed port is "auto" and the sheet type is "photographic". This sheet information indicates that the above combination of sheet settings is printable by the printing apparatus 102. The combination of printable sheet settings described in row 404 can be said to be an example of a combination of sheet settings indicating that borderless printing can be performed.

Return to the description of FIG. 3. In step S301 of FIG. 3, the print function extension unit 207 acquires the sheet information expressed by the sheet information list 401 of FIG. 4 from the printing apparatus 102. The processing proceeds to step S302.

In step S302, the print function extension unit 207 checks the list of combinations of printable sheet settings acquired using the media-col-database attribute and determines whether there is a combination of printable sheet settings with top, bottom, left, and right margins of 0. In a case where there is a combination of printable sheet settings with top, bottom, left, and right margins of 0 (YES in step S302), the processing proceeds to step S303.

In step S303, the print function extension unit 207 determines that the connected printing apparatus 102 is one supporting borderless printing. The processing proceeds to step S304.

In step S304, the print function extension unit 207 stores information indicating that the connected printing apparatus 102 supports borderless printing in the shared information 210. The processing proceeds to step S307.

On the other hand, in a case where, in step S302, the print function extension unit 207 determines NO (NO in step S302), the processing proceeds to step S305.

In step S305, the print function extension unit 207 determines that the connected printing apparatus 102 is one not supporting borderless printing. The processing proceeds to step S306.

In step S306, the print function extension unit 207 stores information indicating that the connected printing apparatus 102 does not support borderless printing, in the shared information 210. The processing proceeds to step S307.

In the present embodiment, the print function extension unit 207 stores the name of the connected printing apparatus 102 and the information indicating whether borderless printing is supported in association with each other. However, the print function extension unit 207 may store other information in the shared information 210. For example, the print function extension unit 207 may store a list of combinations of sheet sizes and margins printable by the printing apparatus 102 in the shared information 210.

Alternatively, the print function extension unit 207 may store information indicating that the connected printing apparatus 102 does not support borderless printing, in association with other information, in the shared information 210. Examples include the connection mode of the printing apparatus 102 and the type of the printing apparatus 102 (such as whether an inkjet printer or a laser printer). Information about sheet sizes and sheet types printable by the printing apparatus 102, information about print functions other than those associated with usable sheets, and the like may also be stored.

After the print function extension unit 207 stores the information about whether the printing apparatus 102 supports borderless printing in the shared information 210 in step S304 or S306, the processing proceeds to step S307.

In step S307, the print function extension unit 207 acquires the PDC 203, and starts PDC editing processing. The processing proceeds to step S308.

In step S308, the print function extension unit 207 acquires the information indicating whether the printing apparatus 102 supports borderless printing from the shared information 210. With the information acquired from the shared information 210, the processing proceeds to step S309.

In step S309, the print function extension unit 207 determines whether the connected printing apparatus 102 supports borderless printing, based on the information acquired from the shared information 210. If YES (YES in step S309), the processing proceeds to step S310.

In step S310, the print function extension unit 207 edits the acquired PDC 203 to add the borderless printing function. The processing proceeds to step S311.

In step S311, the print function extension unit 207 adds a print preview function to the PDC 203. In the present embodiment, the print preview function refers to a function of displaying print data before the extension application 204 transmits the print data to the printing apparatus 102 and printing is started. This print preview function enables checking the selected print settings and the image data reflecting the selected print settings on the display unit 119 of the host computer 101 in advance and selecting whether to execute printing.

In a case where, in step S309, the print function extension unit 207 determines NO (NO in step S309), the processing proceeds to step S311 without the print function extension unit 207 adding the borderless printing function to the PDC 203. In step S311, the print function extension unit 207 adds the print preview function to the PDC 203. With the function(s) added, the processing proceeds to step S312.

In step S312, the print function extension unit 207 updates the PDC 203.

The foregoing processing by the print function extension unit 207 enables use of the borderless printing function in a case where the printing apparatus 102 supports borderless printing, and enables use of the print preview function.

### Example of Screen Displayed by Print Setting Screen Extension Unit

A print setting screen that is displayed by the print setting screen extension unit 205 and where the borderless printing function and the print preview function can be used will be described with reference to FIG. 5A.

The PC is generated based on the PDC 203 edited by the print function extension unit 207. In the present embodiment, a print setting screen 501 is displayed based on the PC that is generated from the PDC 203 edited and updated by the print function extension unit 207 in FIG. 3. In the foregoing steps S310 and S311, the print function extension unit 207 adds the borderless printing function and the print preview function. The user can thus select these functions on the print setting screen 501 of FIG. 5A displayed by the print setting screen extension unit 205.

The print setting screen extension unit 205 is called and launched by the OS when the user instructs the drawing application 201 to display a print setting screen. Based on the PC that can be acquired from the OS, the print setting screen extension unit 205 displays a screen where the user can specify the setting values of the print functions that can be specified.

A control 502 is a control item capable of setting the sheet size for use in printing. For example, items such A4 and Letter can be set.

A control 503 is a control item capable of setting the printing orientation. Portrait and landscape can be set.

A control 504 is a control item capable of selecting whether to print borderless images when printing images on sheets. The control 504 is an example of a first object, and the processing for displaying the control 504 is an example of first displaying.

A control 505 is a control item capable of selecting whether to display a print preview before printing.

A control 506 is a cancel button, by which the print setting screen is closed without reflecting the settings.

A control 507 is an OK button, by which the settings are reflected, and the print setting screen is closed.

In the present embodiment, a case is described in which A4 is selected for the sheet size, portrait is selected for the printing orientation, borderless printing is ON, and print preview display is ON.

When the user selects the foregoing and other print functions and presses the OK button represented by the control 506, the print setting screen extension unit 205 reflects the selected print functions in the PT and ends processing.

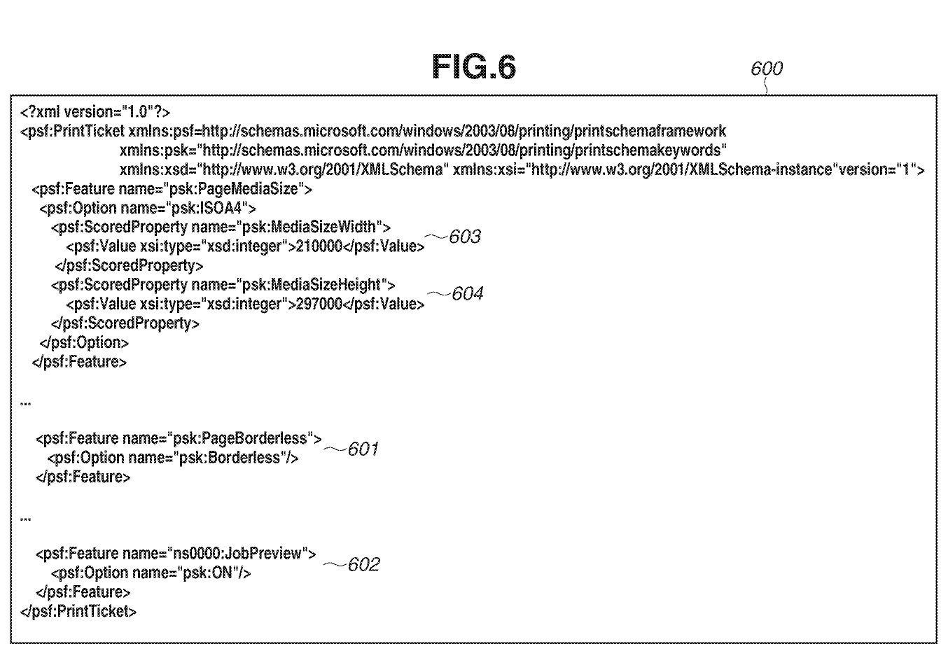

FIG. 6 illustrates an example of a PT 600 where the foregoing print functions are reflected by the print setting screen extension unit 205. A function 601 includes a Feature name "PageBorderless" and an Option name "Borderless". In other words, the PT 600 indicates that it has been updated to a state where the borderless printing function is enabled as a borderless printing function option.

A function 602 includes a Feature name "JobPreview" and an Option name "ON". In other words, the PT 600 indicates that it has been updated to a state where the print preview is ON as a print preview function option.

As described above, when the user selects the borderless printing function and the print preview function via the print setting screen extension unit 205, the print setting screen extension unit 205 updates the PT to modify the PT so that the borderless printing function is enabled, and the print preview display is ON. The PT updated by the print setting screen extension unit 205 is used for the subsequent editing processing of the print data by the print data editing unit 208.

### Print Preview Display by Print Data Editing Unit UI Display Unit

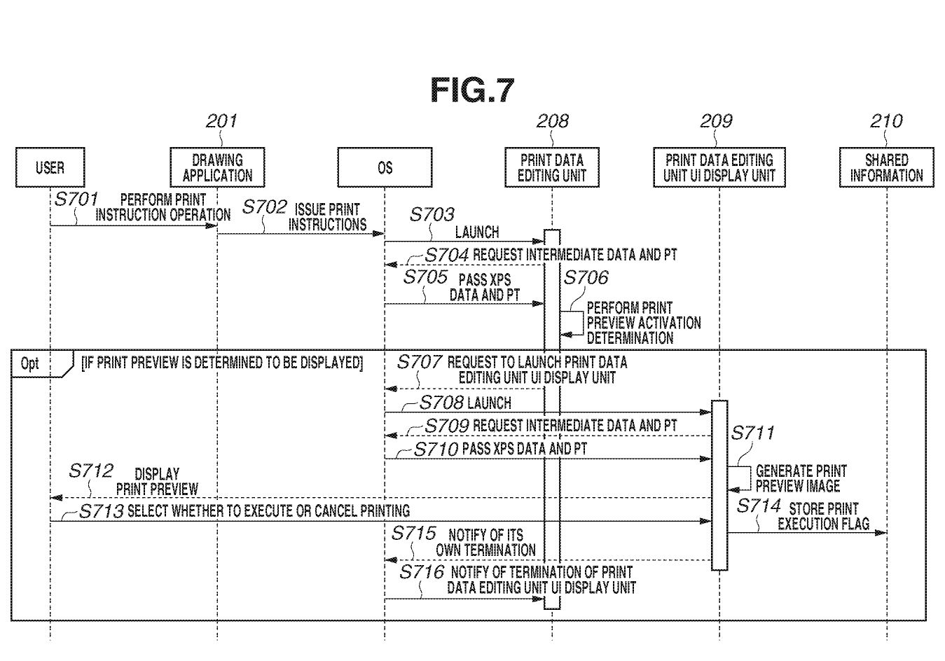

Next, a sequence where the print data editing unit UI display unit 209 is launched by the print data editing unit 208 and displays a print preview will be described with reference to FIG. 7.

In the present embodiment, the user selects the borderless printing function and the print preview function on the print setting screen extension unit 205, and as a result, the borderless printing function is enabled. Accordingly, the PT is updated to a state where the print preview display is ON, and the PT is passed from the drawing application 201 to the print data editing unit 208 along with the intermediate data. In the present embodiment, the print data generation software 202 is to be skipped, and the intermediate data and the PT are passed directly to the print data editing unit 208 of the extension application 204.

In step S701 of FIG. 7, the user performs a print instruction operation for the drawing data generated by the drawing application 201 using the drawing application 201 via the display unit 119.

In step S702, the drawing application 201 issues print instructions to the OS based on the user's print instruction operation.

In step S703, the OS launches the print data editing unit 208 of the extension application 204 based on the print instructions from the drawing application 201.

In step S704, the launched print data editing unit 208 requests intermediate data and PT from the OS.

In step S705, the OS passes data in XPS format (hereinafter, may be referred to as XPS data) as the intermediate data requested by the print data editing unit 208, and passes PT reflecting the print instruction content.

In step S706, the print data editing unit 208 performs determination of whether to activate a print preview, based on the print instruction content described in the acquired PT. In the present embodiment, the print data editing unit 208 determines whether there is a JobPreview feature in the acquired PT 600, and whether the option set in the JobPreview feature is ON. Since there is a JobPreview feature in the acquired PT 600 and the option is set to ON, the print data editing unit 208 here determines to provide a print preview display.

In step S707, to display a print preview, the print data editing unit 208 requests the OS to launch the print data editing unit UI display unit 209.

In step S708, the OS launches the print data editing unit UI display unit 209 based on the UI activation request from the print data editing unit 208. The print data editing unit UI display unit 209 is activated by the OS and starts processing.

In step S709, the print data editing unit UI display unit 209 requests intermediate data and PT from the OS.

In step S710, the OS passes data in XPS format as the intermediate format requested by the print data editing unit UI display unit 209 and passes the PT describing the print instruction content. The data in XPS format passed from the OS to the print data editing unit UI display unit 209 here is the same as the XPS data that the print data editing unit 208 acquires from the OS in step S705.

In step S711, acquiring the XPS data from the OS, the print data editing unit UI display unit 209 generates an image for print preview display. Then, the processing for the print data editing unit UI display unit 209 to generate the image for print preview display (hereinafter, referred to as a print preview image) will be described below.

In step S712, the print data editing unit UI display unit 209 displays a print preview to the user via the display unit 119.

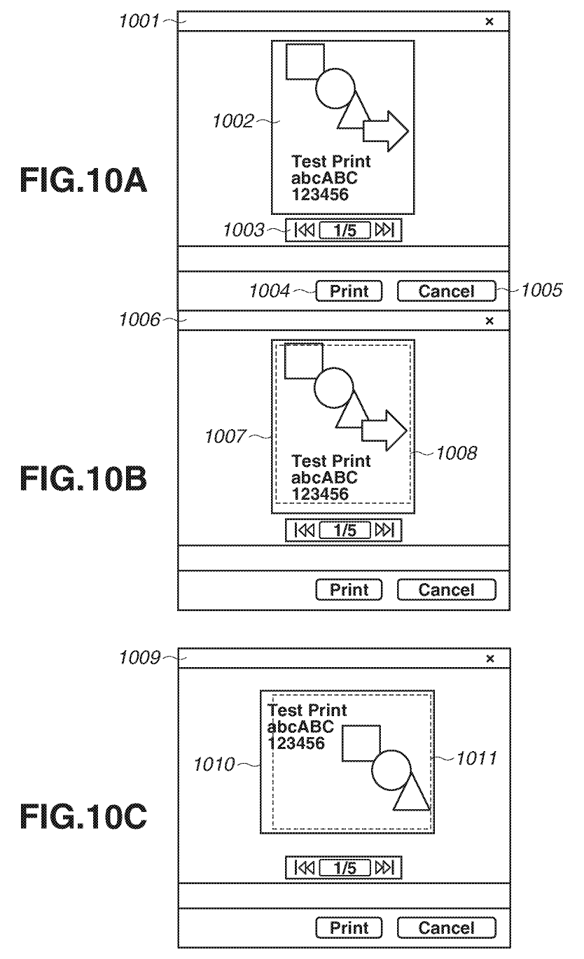

The print preview that the print data editing unit UI display unit 209 displays on the display unit 119 will be described with reference to FIGS. 10A to 10C.

FIG. 10A illustrates a print preview screen 1001, which displays the print preview image in a print preview image display area 1002 based on the intermediate data acquired from the OS.

The print preview screen 1001 includes a control 1003 for page transition when the print job includes a plurality of pages. In the present embodiment, the control 1003 includes page forward buttons for forwarding pages one by one, and page transition buttons for transitioning to the first page and the last page. The control 1003 also includes a textbox for specifying a page that enables transition to a given page.

A control 1004 is an OK button, and a control 1005 is a cancel button. When the user presses each of the controls 1004 and 1005, the pressing result is stored in the shared information 210. The print data editing unit UI display unit 209 ends the display of the print preview screen 1001 when the control 1004 or 1005 is pressed.

The print preview screen 1001 is an example of a print preview screen displayed when borderless printing is not enabled.

Return to the description of FIG. 7. In step S713, the user checks details of the print preview displayed on the display unit 119 and selects whether to execute or cancel printing. More specifically, the user presses the OK button represented by the control 1004 or the cancel button represented by the control 1005 on the foregoing print preview screen 1001.

In step S714, receiving the instruction selected by the user, the print data editing unit UI display unit 209 stores a print execution flag indicating whether to execute or cancel printing in the shared information 210. In step S715, the print data editing unit UI display unit 209 notifies the OS of its own termination and ends processing.

In step S716, receiving the termination notification from the print data editing unit UI display unit 209, the OS notifies the print data editing unit 208 of the termination of the print data editing unit UI display unit 209, and returns the processing to the print data editing unit 208.

### Generation of Print Preview Image When Borderless Printing Is Enabled

As described above, when borderless printing is performed with the print data generation software 202 or extension application 204 using the IPP protocol, the printing apparatus 102 receiving the print data enlarges images based on a predetermined bleed amount and prints the enlarged images.

Meanwhile, the print preview image generated by the print data editing unit UI display unit 209 is generated based on the XPS data acquired from the drawing application 201, and the enlargement processing to be performed by the printing apparatus 102 is not taken into account.

Consequently, if the print data editing unit UI display unit 209 generates the print preview image based on the acquired XPS data, the resulting print preview image includes areas that exceed the sheet boundaries and will not be printed because of the enlargement by the printing apparatus 102 during actual printing. From the user's perspective, despite the check of the print result on the print preview before printing, unintended image loss may actually occur, which potentially leads to misprints in some cases.

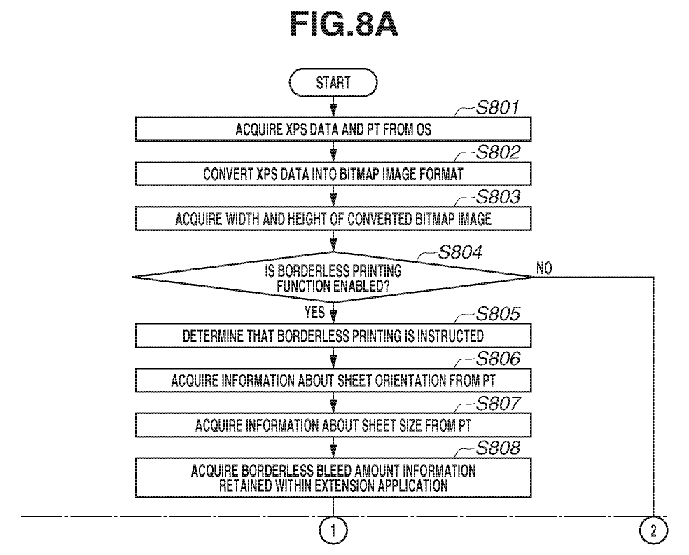

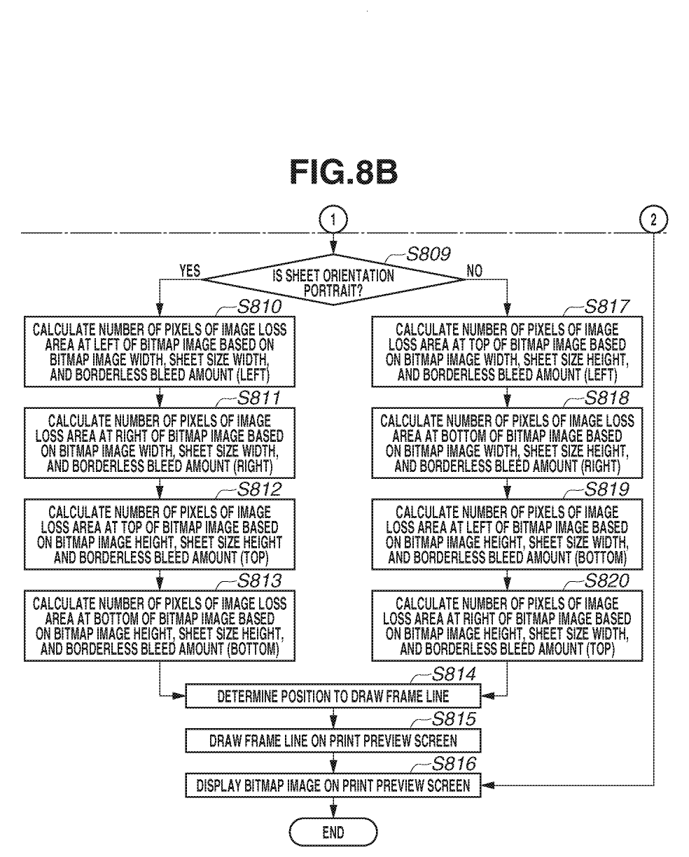

In view of the foregoing issue, in the present embodiment, the processing for generating the print preview image to be performed by the print data editing unit UI display unit 209 when borderless printing is enabled will be described with reference to FIGS. 8A and 8B.

FIGS. 8A and 8B are flowcharts of the processing that is performed by the print data editing unit UI display unit 209 after the processing of step S708 where the OS launches the print data editing unit UI display unit 209 in response to the request from the print data editing unit 208 in FIG. 7.

In step S801, the print data editing unit UI display unit 209 initially acquires XPS data and PT from the OS. The processing proceeds to step S802.

In step S802, the print data editing unit UI display unit 209 converts the acquired XPS data into a bitmap image format for the purpose of display as a print preview on the display unit 119. The processing proceeds to step S803. In step S803, the print data editing unit UI display unit 209 acquires the width and height of the bitmap image converted in step S803.

In step S804, the print data editing unit UI display unit 209 checks the setting values of the borderless printing function in the PT and determines whether the borderless printing function is enabled. Specifically, the print data editing unit UI display unit 209 determines whether there is a PageBorderless feature in the PT and Borderless is selected as the option of the feature. In a case where the borderless printing function is enabled (YES in step S804), the processing proceeds to step S805. The case where the print data editing unit UI display unit 209 determines NO in step S804 will be described below.

In step S805, the print data editing unit UI display unit 209 determines that the target print instructions of the print preview include borderless printing. The processing proceeds to step S806.

In step S806, the print data editing unit UI display unit 209 acquires information about whether the sheet orientation is portrait or landscape from the PT. In step S807, the print data editing unit UI display unit 209 acquires information about the sheet size from the PT.

In the present embodiment, MediaSizeWidth 603 and MediaSizeHeight 604 defined in the PT 600 are the information about the sheet size. More specifically, in step S806, the print data editing unit UI display unit 209 acquires 210000 defined in MediaSizeWidth 603 of the PT 600 as the sheet size width.

Further, the print data editing unit UI display unit 209 acquires 297000 defined in MediaSizeHeight 604 of the PT 600 as the sheet size height. With the information about the sheet orientation and sheet size set in the PT 600 acquired, the processing proceeds to step S808.

In step S808, the print data editing unit UI display unit 209 acquires borderless bleed amount information about the printing apparatus 102 retained within the extension application 204. "Within the extension application 204" may refer to the borderless bleed amount information being stored in the execution program of the extension application 204 itself, or the borderless bleed amount information being stored in the shared information 210. Alternatively, the borderless bleed amount information may be stored in a server or the like outside the extension application 204, and the extension application 204 may retain information for accessing the server or the like where the borderless bleed amount information is stored.

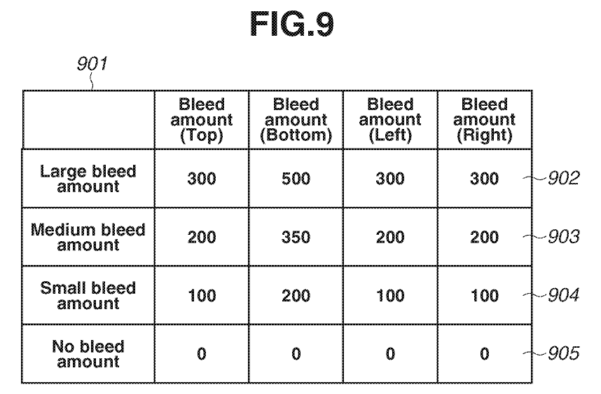

An example of borderless bleed amount information retained by the printing apparatus 102 will now be described with reference to FIG. 9. FIG. 9 is a bleed amount list 901 listing settable values of borderless bleed amounts in a printing apparatus.

With the printing apparatus 102 having the borderless bleed amounts illustrated in FIG. 9, the user can select desired borderless bleed amounts.

When "large bleed amount" in row 902 of the bleed amount list 901 is selected, the printing apparatus 102 enlarges images based on bleed amounts of 300 in the top, left, and right directions, and a bleed amount of 500 in the bottom direction, relative to the image data in the received print data. This can ensure the elimination of margins as much as possible, at the expense of greater image data loss.

Similarly, "medium bleed amount" in row 903 of the bleed amount list 901 causes the printing apparatus 102 to enlarge images based on bleed amounts of 200 in the top, left, and right directions, and a bleed amount of 350 in the bottom direction, relative to the received image data.

"Small bleed amount" in row 904 causes the printing apparatus 102 to enlarge images based on bleed amounts of 100 in the top, left, and right directions, and a bleed amount of 200 in the bottom direction, relative to the image data in the received image data.

The smaller the settable values of the borderless bleed amounts in the bleed amount list 901, the less the image data loss, but with a higher possibility of occurrence of margins. "No bleed amount" in row 905 of the bleed amount list 901 does not cause the printing apparatus 102 to enlarge images relative to the received image data. This setting typically results in margins in most cases but be effective when the user wishes to perform printing near the edges like when printing the address side of postcards, for example.

As described above, there is a tradeoff between the possibility of occurrence of margins and image loss areas during borderless printing, in accordance with the borderless bleed amounts of the printing apparatus.

In the present embodiment, the extension application 204 internally retains the borderless bleed amounts of the printing apparatus 102 for "large bleed amount" and uses the borderless bleed amounts in generating the print preview image. The reason is that, in such a scenario, there is a high possibility of unexpected print results for the user due to image loss, which is considered to be the most significant disadvantage to the user.

The configuration of the present embodiment enables the user to realize that unexpected print results may occur from the borderless bleed amounts of the printing apparatus 102. In such a case, the user can select to cancel printing on the print preview screen, and refrain from printing or take actions such as modifying the print settings to retry printing.

Return to the description of FIGS. 8A and 8B. In step S808, the print data editing unit UI display unit 209 acquires the borderless bleed amount information retained in the extension application 204 itself. The processing proceeds to step S809.

In step S809, the print data editing unit UI display unit 209 refers to the information about the sheet orientation acquired from the PT and determines whether the sheet orientation is portrait or landscape. In a case where the sheet orientation is portrait (YES in step S809), the processing proceeds to step S810. The processing when the print data editing unit UI display unit 209 determines NO in step S809 will be described below.

In step S810, the print data editing unit UI display unit 209 calculates the number of pixels of the image loss area at the left of the bitmap image where image loss occurs during printing, from the bitmap image width, the sheet size width, and the borderless bleed amount in the left direction. More specifically, the print data editing unit UI display unit 209 calculates the number of pixels of the borderless bleed amount on the bitmap image by determining the ratio of the borderless bleed amount in the left direction to the sheet size width and multiplying the bitmap image width by the ratio. With the image loss area at the left of the bitmap image thus calculated in step S810, the processing proceeds to step S811.

In step S811, the print data editing unit UI display unit 209 calculates the number of pixels of the image loss area at the right of the bitmap image where image loss occurs during printing at the printing apparatus 102, from the bitmap image width, the sheet size width, and the borderless bleed amount in the right direction.

With the image loss area at the right of the bitmap image thus calculated in step S811, the processing proceeds to step S812.

In step S812, the print data editing unit UI display unit 209 calculates the number of pixels of the image loss area at the top of the bitmap image where image loss occurs during printing at the printing apparatus 102, from the bitmap image height, the sheet size height, and the borderless bleed amount in the top direction.

With the image loss area at the top of the bitmap image calculated in step S812, the processing proceeds to step S813.

In step S813, the print data editing unit UI display unit 209 calculates the number of pixels of the image loss area at the bottom of the bitmap image where image loss occurs during printing, from the bitmap image height, the sheet size height, and the borderless bleed amount in the bottom direction. With the image loss area at the bottom of the bitmap image thus calculated in step S813, the processing proceeds to step S814.

In step S814, the print data editing unit UI display unit 209 determines the position to draw a frame line for expressing the areas where image loss occurs, based on the numbers of pixels of the image loss areas on the bitmap image calculated in steps S810 to S813. The processing proceeds to step S815.

In step S815, the print data editing unit UI display unit 209 draws the frame line on the print preview screen. In the subsequent step S816, the print data editing unit UI display unit 209 displays the bitmap image for print preview display on the print preview screen. Steps S815 and S816 are an example of second displaying.

In the present embodiment, the bitmap image for print preview display is thus displayed on the print preview screen, and the frame line for expressing the areas where image loss occurs during borderless printing is drawn. The areas where image loss occurs during printing at the printing apparatus 102 can thereby be expressed on the print preview screen.

A print preview screen displayed by the print data editing unit UI display unit 209 when the borderless printing function is enabled will be described with reference to FIG. 10B.

A print preview screen 1006 of FIG. 10B is an example of the screen where the bitmap image for print preview and the frame line for expressing the areas where image loss occurs are displayed in a superimposed manner by the processing of FIGS. 8A and 8B when the borderless printing function is enabled. The areas where image loss occurs during printing, calculated by the print data editing unit UI display unit 209 in steps S810 to S813 of FIG. 8B, are expressed based on the numbers of pixels on the bitmap image.

In other words, the print preview screen 1006 shows that the areas of the bitmap image outside the frame line represented by an image loss area display frame line 1008 are where the image can be lost when the printing apparatus 102 enlarges and prints the image based on the borderless bleed amounts.

In the present embodiment, the frame line indicating the image loss areas is drawn in a dotted line. However, the image loss areas may be indicated by other methods. For example, a rectangle that masks the areas of the bitmap image corresponding to the calculated image loss areas may be drawn so that the areas where image loss occurs during printing are not displayed on the print preview screen.

Next, the case where the print data editing unit UI display unit 209 determines NO in step S809 of FIG. 8B will be described. In a case where the determination in step S809 is no (NO in step S809), i.e., the sheet orientation is determined to be landscape, the processing proceeds to step S817.

The borderless bleed amounts of the printing apparatus 102 illustrated in FIG. 9 are the bleed amounts in the top, bottom, left, and right directions when the sheet orientation is portrait. In typical inkjet printers and the like, sheets are often passed portrait. As employed herein, sheets are also to be constantly passed portrait. In displaying a print preview with the sheet orientation set to landscape, the values of the borderless bleed amounts therefore need to be considered as rotated by 90 degrees (º).

More specifically, when the sheet orientation is set to landscape, the right margin needs to be applied to the top of the print preview image, the left margin to the bottom of the image, the bottom margin to the left of the image, and the top margin to the right of the image.

In step S817, the print data editing unit UI display unit 209 calculates the number of pixels of the image loss area at the top of the bitmap image where image loss occurs during printing, from the bitmap image width, the sheet size height, and the borderless bleed amount in the left direction. With the image loss area at the top of the bitmap image calculated in step S817, the processing proceeds to step S818.

In step S818, the print data editing unit UI display unit 209 calculates the number of pixels of the image loss area at the bottom of the bitmap image where image loss occurs during printing, from the bitmap image width, the sheet size height, and the borderless bleed amount in the right direction. With the image loss area at the bottom of the bitmap image calculated in step S818, the processing proceeds to step S819.

In step S819, the print data editing unit UI display unit 209 calculates the number of pixels of the image loss area at the left of the bitmap image where image loss occurs during printing, from the bitmap image height, the sheet size width, and the borderless bleed amount in the bottom direction. With the image loss area at the left of the bitmap image calculated in step S819, the processing proceeds to step S820.

In step S820, the print data editing unit UI display unit 209 calculates the number of pixels of the image loss area at the right of the bitmap image where image loss occurs during printing, from the bitmap image height, the sheet size width, and the borderless bleed amount in the top direction. With the image loss area at the right of the bitmap image calculated in step S820, the processing proceeds to step S814. The processing of steps S814 to S816 is similar to the foregoing, and a description thereof will be omitted.

A print preview screen 1009 displayed by the print data editing unit UI display unit 209 when the borderless printing function is enabled, and the sheet orientation is set to landscape will be described with reference to FIG. 10C.

The print preview screen 1009 of FIG. 10C is an example of the screen that the print data editing unit UI display unit 209 displays by performing the processing of FIGS. 8A and 8B when the borderless printing function is enabled, and the sheet orientation is set to landscape. An image loss area display frame line 1011 is the frame line drawn by converting the areas where image loss occurs during printing, calculated by the print data editing unit UI display unit 209 in steps S817 to S820 of FIG. 8B, into numbers of pixels on the bitmap image. Since the sheet orientation is set to landscape, a print preview image display area 1010 also displays a landscape image.

However, when the printing apparatus 102 prints actually, sheets are passed portrait, and printing is performed by enlarging images through the application of the borderless bleed amounts to portrait sheets. The image loss areas are therefore calculated and the image loss area display frame line 1011 is drawn on the print preview screen 1009 by taking into account the borderless bleed amounts to be applied during sheet passing.

The processing in the case where the print data editing unit UI display unit 209 determines NO in step S804 of FIG. 8A, i.e., determines that the borderless printing function is not enabled will be described. In a case where, in step S804, the borderless printing function is determined to not be enabled (NO in step S804), the processing proceeds to step S816. In step S816, the print data editing unit UI display unit 209 displays a print preview using the bitmap image.

The above is an example where the print function extension unit 207 of the extension application 204 makes the borderless printing function and the print preview function available. The example also deals with a case where the print data editing unit UI display unit 209 provides a print preview display when the borderless printing function is enabled after selection of the function by the print setting screen extension unit 205. The method described in the present embodiment can reduce the likelihood of misprints from the user's perspective by presenting in advance the areas where image loss occurs during actual printing in the print preview of the extension application 204.

Another conceivable method is to edit the XPS data to generate an image with the image loss areas cropped for the purpose of print preview display and provide the print preview display using the edited image data. However, this approach causes performance degradation since the print data editing unit UI display unit 209 needs to edit the XPS data. By contrast, the method of the present embodiment minimizes performance degradation associated with the XPS editing and can reduce time and resource consumption needed for print preview display.

### Second Embodiment

The first embodiment has dealt with the processing where, in performing borderless printing, the print data editing unit UI display unit 209 provides a print preview display when the borderless printing function is enabled after the borderless printing function is selected using the print setting screen extension unit 205.

In some use cases, the user may want to print images as rotated 180º. Among the most common examples is when the user wants to print addresses on envelopes. Depending on the application that generates the image data and the method for feeding envelope paper to the printer that prints, images can be printed in an inverted orientation on the envelopes if the images are printed as is. In such a case, envelopes can be printed in the proper orientation by rotating the images to be printed by 180º before printing.

The present embodiment proposes a method for such cases, where the method for calculating the image loss areas is switched depending on whether 180º rotation is selected when the print data editing unit UI display unit 209 displays a print preview screen as described in the first embodiment.

Even in the present embodiment, the display on the print preview screen is provided without rotating the image itself by 180º. As described in the first embodiment, another conceivable approach would be to edit the XPS data for print preview display to generate a 180º-rotated target image and provide the print preview display using the edited image data. However, such an approach also causes performance degradation associated with the editing of the XPS data. The method of the present embodiment can provide a way for the user to accurately preview the print result before printing while minimizing performance degradation.

In the following description, system configurations not mentioned in particular are similar to those of the first embodiment, and descriptions thereof will be omitted. Processing procedures not mentioned in particular in the following description are similar to those of the first embodiment, and descriptions thereof will be omitted.

Selection of 180º Rotation Function on Print Setting Screen and Launch of Print Data Editing Unit

A print setting screen displayed by the print setting screen extension unit 205 in the present embodiment, where 180º rotation can be used, will initially be described with reference to a print setting screen 508 illustrated in FIG. 5B.

For images edited and updated by the print function extension unit 207, PC is generated based on PDC (not illustrated) to which 180º rotation function is added. In other words, the print function extension unit 207 of the extension application 204 adds the 180º image rotation function.

As a result, the user can select such functions on the print setting screen 508 displayed by the print setting screen extension unit 205.

A control 509 is a control item capable of selecting whether to print images as rotated 180º when printing the images on print sheets. The control 509 is an example of a third object, and the processing for displaying the control 509 is an example of fourth displaying. In the present embodiment, that borderless printing ON and print preview display ON are selected, as well as the 180º image rotation function ON, using the control items on the print setting screen 508 displayed in the display step.

When the user selects the foregoing print functions and other print functions and presses the OK button on the print setting screen 508, the print setting screen extension unit 205 reflects the selected print functions in the PT and ends processing.

The borderless printing function and the 180º image rotation function are enabled based on the user's print instruction operations on the drawing application 201. As a result, the PT updated to a state where the print preview display is ON is passed from the drawing application 201 to the print data editing unit 208 along with intermediate data.

Even in the present embodiment, the print data generation software 202 is to be skipped, and the intermediate data and the PT are directly passed to the print data editing unit 208 of the extension application 204. The sequence from the launch of the print data editing unit 208 to the launch of the print data editing unit UI display unit 209 is similar to that described with reference to FIG. 7. A description thereof will thus be omitted.

### Generation of Print Preview Image When 180º Image Rotation and Borderless Printing Are Enabled

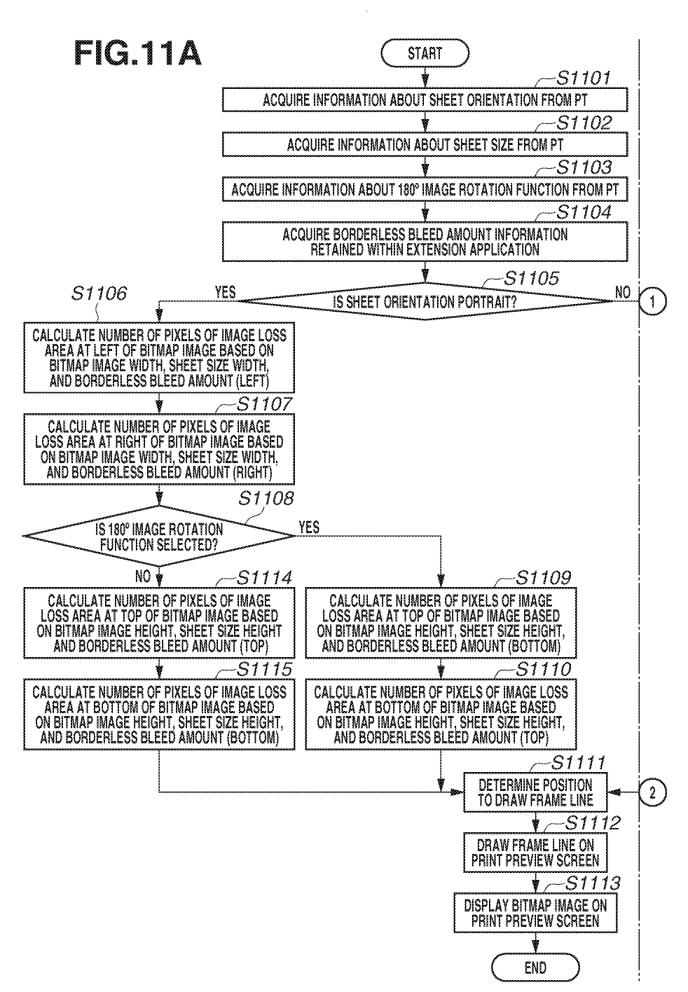

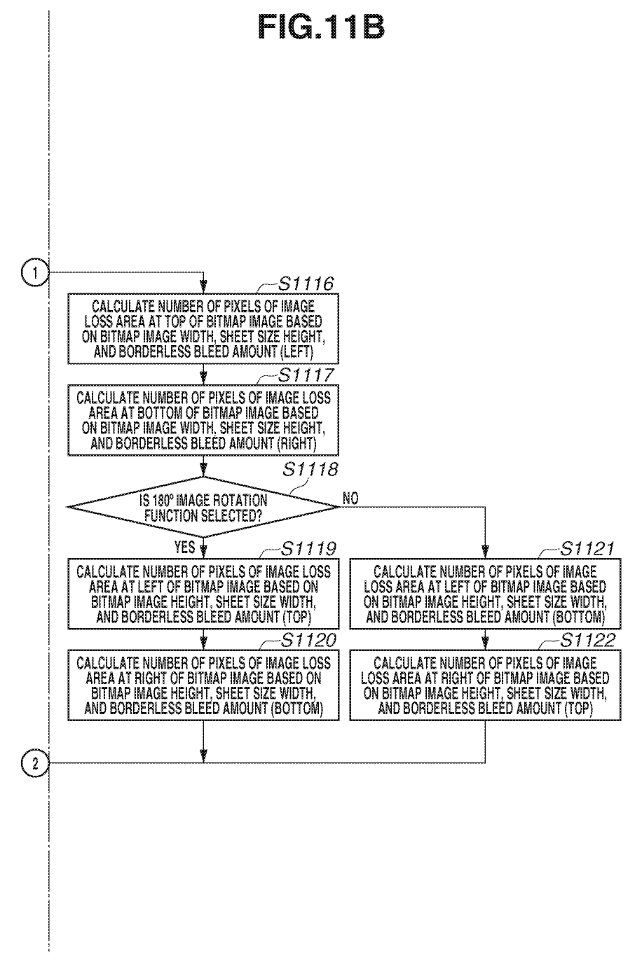

Print preview image generation processing that the print data editing unit UI display unit 209 performs when the 180º image rotation function and the borderless printing function are enabled will be described with reference to FIGS. 11A and 11B.

FIGS. 11A and 11B apply to the processing after the print data editing unit UI display unit 209 performs the processing of steps S801 to S805 in FIG. 8A and determines that the borderless printing function is enabled.

The processing of steps S1101 and S1102 is similar to that of steps S806 and S807 of FIG. 8A. A description thereof will thus be omitted.

With the processing up to step S1102 completed, the processing proceeds to step S1103. In step S1103, the print data editing unit UI display unit 209 acquires information about whether the 180º image rotation function is enabled from the PT. The processing proceeds to step S1104. The processing of step S1104 is similar to that of step S808. A description thereof will thus be omitted.

In step S1105, the print data editing unit UI display unit 209 determines whether the sheet orientation is portrait. If YES (YES in step S1105), the processing proceeds to step S1106. The processing when the print data editing unit UI display unit 209 determines NO in step S1105 will be described below.

The processing of steps S1106 and S1107 is similar to that of steps S810 and S811 of FIGS. 8A and 8B. With the processing up to step S1107 completed, the processing proceeds to step S1108.

In step S1108, the print data editing unit UI display unit 209 determines whether the 180º image rotation function is selected based on the setting value of the 180º image setting function acquired from the PT. In a case where the 180º image rotation function is selected (YES in step S1108), the processing proceeds to step S1109. The processing when the print data editing unit UI display unit 209 determines NO in step S1108 will be described below.

In the present embodiment, as illustrated in FIG. 9, since the bleed amounts in the left and right directions match each other, it is unnecessary to interchange the bleed amounts even when the 180º rotation function is selected. Whether the 180º rotation function is selected is thus determined in step S1108 after steps S1106 and 1107. However, in a case where the bleed amounts in the left and right directions are different, the determination of step S1108 may be performed prior to step S1106, and the bleed amounts may be interchanged based on the determination. The same applies to steps S1116 to S1118 to be described below.

In step S1109, the print data editing unit UI display unit 209 calculates the number of pixels of the image loss area at the top of the bitmap image where image loss occurs during printing at the printing apparatus 102. The number of pixels is calculated based on the bitmap image height, the sheet size height, and the borderless bleed amount in the bottom direction.

The reason is that in the present embodiment, when the 180º image rotation function is selected, the printing apparatus 102 prints images upside down while the print data editing unit UI display unit 209 displays a print preview based on a non-inverted image.

The image data that the print data editing unit UI display unit 209 acquires from the OS when launched does not reflect the result of editing by the print data editing unit 208. When the print data editing unit UI display unit 209 edits the XPS image data, the print data editing unit UI display unit 209 therefore needs to perform the XPS editing processing by itself.

For this reason, when the 180º image rotation function is selected, as in the processing of step S1109, the print data editing unit UI display unit 209 interchanges the top and bottom bleed amounts in calculating the numbers of pixels of the image loss areas on the bitmap image. With this configuration, the image loss areas when the image is inverted upside down upon actual printing are represented. With the processing of step S1109 completed, the processing proceeds to step S1110.

In step S1110, the print data editing unit UI display unit 209 calculates the number of pixels of the image loss area at the bottom of the bitmap image where image loss occurs during printing at the printing apparatus 102. The number of pixels is calculated based on the bitmap image height, the sheet size height, and the borderless bleed amount in the top direction. With the image loss areas of the bitmap image calculated up to step S1110, the processing proceeds to step S1111. The processing of steps S1111 to S1113 is similar to that described in steps S814 to S816 of FIG. 8B. A description thereof will thus be omitted.

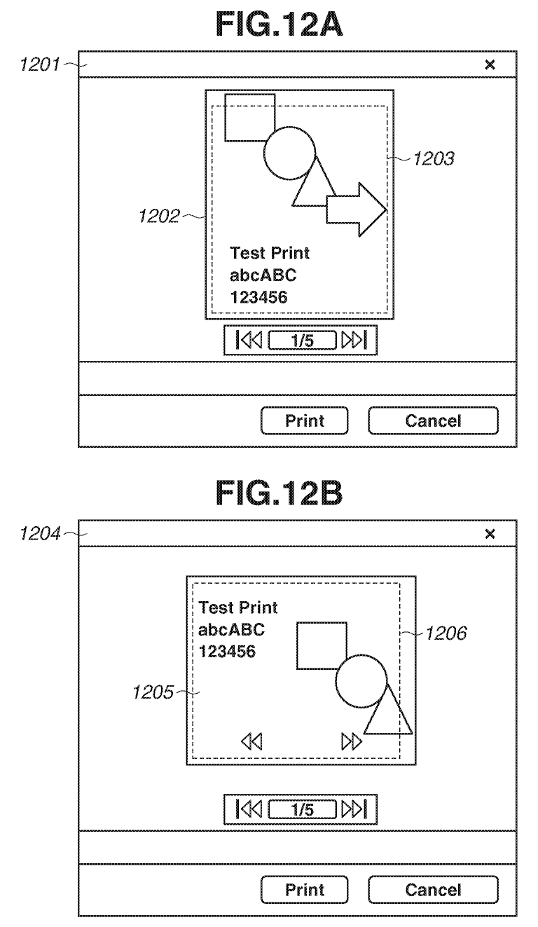

Print preview screens generated by the foregoing processing and displayed by the print data editing unit UI display unit 209 when the 180º image rotation function and the borderless printing function are enabled will be described with reference to FIGS. 12A and 12B.

FIG. 12A illustrates a print preview screen 1201, which is an example of the screen when the 180º rotation function and the borderless printing function are enabled. On the print preview screen 1201, the print data editing unit UI display unit 209 displays the bitmap image for print preview and the frame line for expressing the areas where image loss occurs during borderless printing in a superimposed manner.

A preview image display area 1202 on the print preview screen 1201 displays the bitmap image generated by the print data editing unit UI display unit 209 based on the XPS image data acquired from the OS. Since the XPS image data on which the bitmap image is based does not reflect the 180º image rotation, the same image as when the 180º image rotation is not enabled is displayed.

Meanwhile, an image loss area display frame line 1203 calculated based on the processing of FIGS. 11A and 11B accurately represents the image loss areas to appear when the printing apparatus 102 prints the image as rotated 180º, through the calculation with the top and bottom borderless bleed amounts inverted.

Return to the description of FIGS. 11A and 11B. In a case where, in step S1108 of FIG. 11A, the 180º image rotation function is not selected (NO in step S1108), the processing proceeds to step S1114. Here, the processing of steps S1114 and S1115 is similar to that of steps S812 and S813 of FIG. 8B. A description thereof will be omitted.

In a case where the determination in step S1105 of FIG. 11A is no (NO in step S1105), i.e., the sheet orientation is determined to be landscape, the processing proceeds to step S1116.

The processing of steps S1116 and S1117 is similar to that of steps S817 and S818 described with reference to FIG. 8B. A description thereof will thus be omitted. With the processing up to step S1117 completed, the processing proceeds to step S1118.

In step S1118, the print data editing unit UI display unit 209 determines whether the 180º image rotation function is selected, based on the PT setting value. In a case where the determination of step S1118 is yes (YES in step S1118), i.e., the sheet orientation is landscape and the 180º image rotation function is enabled, the processing proceeds to step S1119.

In step S1119, the print data editing unit UI display unit 209 calculates the number of pixels of the image loss area at the left of the bitmap image where image loss occurs during printing at the printing apparatus 102. With the number of pixels of the image loss area at the left of the bitmap image calculated in step S1119, the processing proceeds to step S1120. The number of pixels here is calculated based on the bitmap image height, the sheet size width, and the borderless bleed amount in the top direction.

In step S1120, the print data editing unit UI display unit 209 calculates the number of pixels of the image loss area at the right of the bitmap image where image loss occurs during printing at the printing apparatus 102. The number of pixels here is calculated based on the bitmap image height, the sheet size width, and the borderless bleed amount in the bottom direction.

With the image loss areas of the bitmap image calculated in steps S1119 and S1120, the processing proceeds to step S1111. The processing of steps S1111 to S1113 is similar to that described in steps S814 to S816 of FIG. 8B. A description thereof will thus be omitted.

FIG. 12B illustrates a print preview screen 1204, which is generated by the foregoing processing and displayed when the 180º image rotation function and the borderless printing function are enabled, and the sheet orientation is landscape.

A preview image display area 1205 on the print preview screen 1204 of FIG. 12B displays the bitmap image generated by the print data editing unit UI display unit 209 based on the XPS image data acquired from the OS. The XPS image data on which the bitmap image is based does not reflect the 180º image rotation, and the same image as that when the 180º image rotation function is not enabled is displayed.

Meanwhile, an image loss area display frame line 1206 calculated based on the processing of FIGS. 11A and 11B accurately represents the image loss areas to appear when the printing apparatus 102 prints the image as rotated 180º, through the calculation with the top and bottom borderless bleed amounts.

Return to the description of FIGS. 11A and 11B. In a case where, in step S1118 of FIG. 11B, the 180º image rotation function is not selected (NO in step S1118), the processing proceeds to step S1121. Here, the processing of steps S1121 and S1122 is similar to that of steps S819 and S820 of FIG. 8B. A description thereof will thus be omitted.

An example of the case where the 180º image rotation function and the borderless printing function are both selected using the print setting screen extension unit 205 of the extension application 204 has been described above. In such a case, the print data editing unit UI display unit 209 provides a print preview display for situations where the 180º image rotation and borderless printing functions are enabled.

The method described in the present embodiment can be expected to provide the effect of minimizing performance degradation associated with XPS data editing by the print data editing unit UI display unit 209.

Moreover, even when images are rotated 180º for printing, the present embodiment provides a method that enables checking in advance the image loss areas to appear when the printing apparatus 102 enlarges the images. The print preview screen can thus properly display what the print result will look like.

### Third Embodiment

The first and second embodiments have dealt with a method for calculating the image loss areas based on the borderless bleed amounts of the printing apparatus 102 stored in the extension application 204 in advance and displaying the image loss areas on the print preview screen in a superimposed manner.

However, when printing apparatuses perform borderless printing, the borderless bleed amounts to be used for image enlargement are not fixed values and may vary with the type of printing apparatus. A printing apparatus may have multiple sets of selectable bleed amounts. Thus, the extension application 204 may also perform acquiring of information about the borderless bleed amounts of a printing apparatus or other printer that is selected as the transmission destination of print data, directly from that device. Alternatively, the host computer 101 may instruct a printing apparatus about the borderless bleed amounts and have the printing apparatus print using the specified borderless bleed amounts.

In view of the foregoing issues, a third embodiment will now be proposed. In the following description, system configurations not mentioned in particular are similar to those of the first embodiment, and descriptions thereof will be omitted. Processing procedures not mentioned in particular in the following description are similar to those of the first embodiment, and descriptions thereof will be omitted.

Processing that the print function extension unit 207 performs to acquire information about the borderless bleed amounts from the printing apparatus 102 and edit PDC based on the acquired information will initially be described.

The print function extension unit 207 issues an IPP Get-Printer-Attributes operation to the printing apparatus 102 that is selected as the transmission destination of print data. The information about settable values of the borderless bleed amounts of the printing apparatus 102 is thereby requested.

The printing apparatus 102 responds to the request issued by the print function extension unit 207 with the information about the settable values of the borderless bleed amounts. The information illustrated in FIG. 9 can be an example of the response from the printing apparatus 102 with the information about the settable values of the borderless bleed amounts.

Aside from the settable values, the response from the printing apparatus 102 may include information about the borderless bleed amounts currently selected by the printing apparatus 102 and default setting values of the borderless bleed amounts settable on the printing apparatus 102. In the present embodiment, "medium bleed amount" in row 903 of FIG. 9 is treated as the default setting values and the currently selected values.

The print function extension unit 207 acquires the information about the borderless bleed amounts of the printing apparatus 102 as the response to the Get-Printer-Attributes operation, and then stores the information in the shared information 210.

Moreover, the print function extension unit 207 edits the PDC based on the acquired information about the borderless bleed amounts and registers the settable values and default setting values of the borderless bleed amounts as information about the print functions of the printing apparatus 102 for update. More specifically, the print function extension unit 207 registers "large bleed amount", "medium bleed amount", "small bleed amount", and "no bleed amount" with the PDC as settable values, and registers "medium bleed amount" as the default setting values of the borderless bleed amounts.

As employed herein, "no bleed amount" means that borderless printing is performed by enlarging images to zero sheet margins as needed.

The information about the borderless bleed amounts for the print function extension unit 207 to acquire via the IPP Get-Printer-Attributes operation may be known attribute values defined as the IPP standard specification. Alternatively, the information may be custom attribute values defined by each vendor providing the extension application 204.

In such a manner, the print function extension unit 207 acquires the information about the settable borderless bleed amounts of the printing apparatus 102 from the printing apparatus 102, updates the PDC, and ends processing.

An example of a screen that is configured based on the PC generated from the PDC updated by the print function extension unit 207 and is displayed by the print setting screen extension unit 205 will be described with reference to FIG. 5C.

The PC is generated based on PDC (not illustrated) to which a borderless bleed amount selection function is added by the print function extension unit 207. In other words, in the present embodiment, the print function extension unit 207 adds the borderless printing function, the print preview function, and the borderless bleed amount selection function. This enables the user to select these functions on the print setting screen 510 displayed by the print setting screen extension unit 205.

A control 511 is a control item capable of selecting the settable values of the borderless bleed amounts acquired from the printing apparatus 102. The values selected via the control 511 serve as the setting values based on which the printing apparatus 102 enlarges images when performing borderless printing. The control 511 is an example of a second object. The processing for displaying the control 511 is an example of third displaying.

The control 511 may be displayed in response to the selection of the borderless printing via the control 504.

In the present embodiment, "large bleed amount", "medium bleed amount", "small bleed amount", and "no bleed amount" added by the print function extension unit 207 can be selected. In the present embodiment, "large bleed amount" is selected using the control 511 of the print setting screen 510, along with the borderless printing function ON and the print preview display ON.

When the user selects the foregoing print functions and other print functions and presses the OK button on the print setting screen 510, the print setting screen extension unit 205 reflects the selected print functions in the PT and ends processing.

Then, the borderless printing function is turned ON and "large bleed amount" are selected based on the user's print instruction operations on the drawing application 201. As a result, the PT updated to a state where the print preview display is ON is passed from the drawing application 201 to the print data editing unit 208 along with intermediate data. Even in the present embodiment, the print data generation software 202 is to be skipped, and the intermediate data and the PT are directly passed to the print data editing unit 208 of the extension application 204.

Processing of Print Data Editing Unit and Print Data Editing Unit UI Display Unit When Borderless Bleed Amounts Are Set

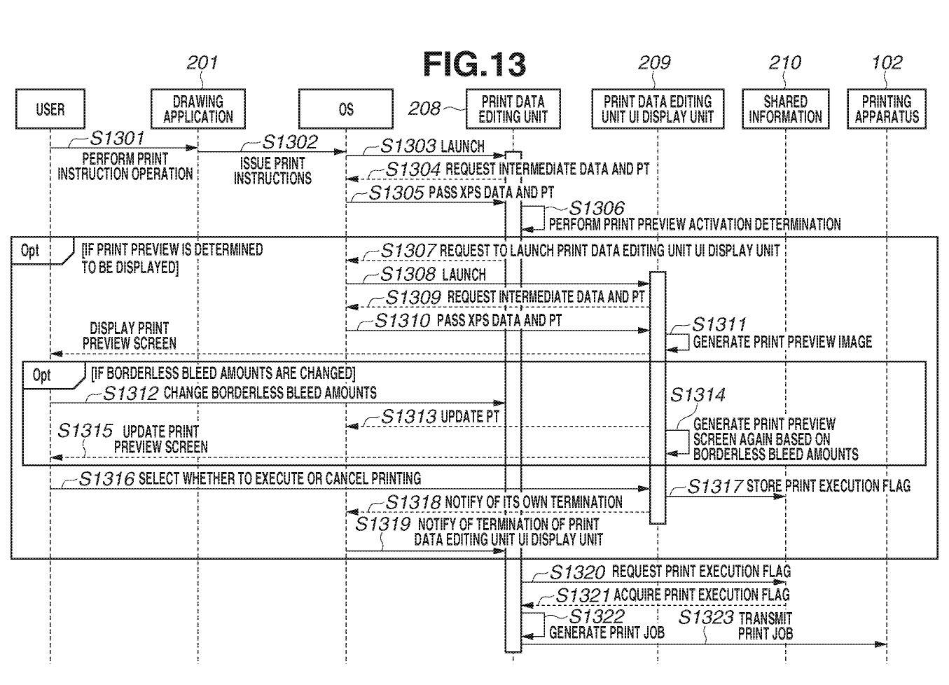

Processing performed by the print data editing unit 208 and the print data editing unit UI display unit 209 when the borderless printing function is enabled and "large bleed amount" is set will be described with reference to the sequence diagram of FIG. 13.

The processing of steps S1301 to S1310 in FIG. 13 is similar to that of steps S701 to S710 illustrated in FIG. 7. A description thereof will thus be omitted.

In step S1311, the print data editing unit UI display unit 209 generates a print preview image to be displayed on the display unit 119. As in the processing described with reference to the flowchart of FIG. 7 in the first embodiment, the print data editing unit UI display unit 209 converts the XPS data into a bitmap image. The print data editing unit UI display unit 209 also calculates the image loss areas of the bitmap image based on the information about the sheet orientation, the sheet size, and the borderless bleed amounts, and draws an image loss area display frame line based on the calculations of the image loss areas.

In the present embodiment, the borderless bleed amounts for calculating the image loss areas are setting values that are selected by the user and reflected in the PT among the settable values acquired from the printing apparatus 102. Since the setting values reflected in the PT are "large bleed amount", the print data editing unit UI display unit 209 acquires the borderless bleed amounts in the respective directions that correspond to "large bleed amount" stored in the shared information 210. Specifically, the print data editing unit UI display unit 209 acquires the borderless bleed amounts in the top, bottom, left, and right directions, and calculates the image loss areas based on the respective borderless bleed amounts corresponding to "large bleed amount".

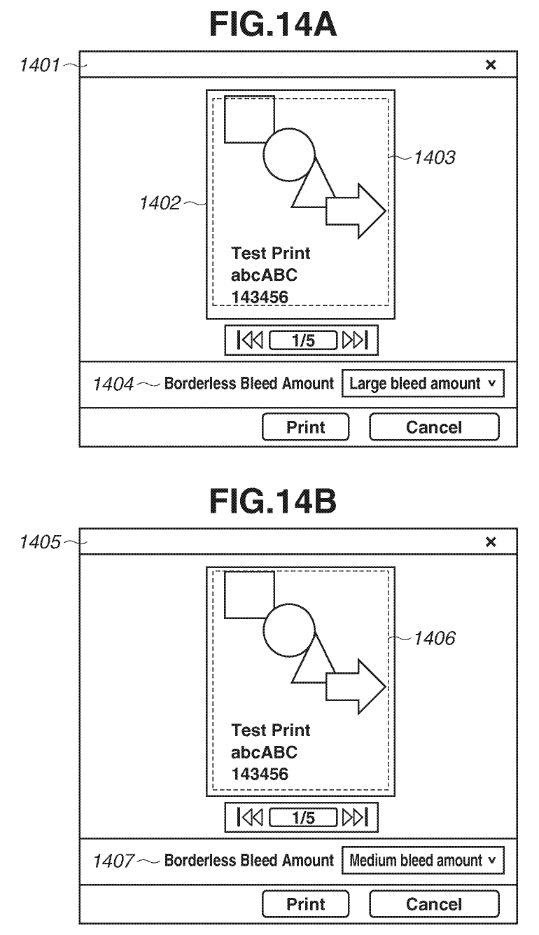

A print preview screen 1401 in the state where the borderless bleed amounts are selected will be described with reference to FIG. 14A.

The print preview screen 1401 is a screen where the print data editing unit UI display unit 209 displays the bitmap image for print preview and the frame line for expressing the areas where image loss occurs in a superimposed manner when the borderless printing function is enabled.

The bitmap image generated by the print data editing unit UI display unit 209 based on the XPS image data acquired from the OS is displayed in a preview image display area 1402 on the print preview screen 1401.

An image loss area display frame line 1403 is the frame line that is drawn by the print data editing unit UI display unit 209. The print data editing unit UI display unit 209 draws the frame line by acquiring the setting values selected by the user via the control 511 and reflected in the PT, and calculating the image loss areas.

The print preview screen 1401 according to the present embodiment includes a control 1404. The control 1404 is a control item capable of selecting the settable values of the borderless bleed amounts acquired from the printing apparatus 102. The control 1404 is an example of the second object, and the processing for displaying the control 1404 is an example of the third displaying.

The borderless bleed amounts selected via the control 1404 are the setting values based on which the printing apparatus 102 enlarges images when performing borderless printing. When the user changes the bleed amount setting using the control 1404, the print data editing unit UI display unit 209 acquires the borderless bleed amounts based on the changed bleed amount setting. After the acquisition of the borderless bleed amounts, the print data editing unit UI display unit 209 recalculates the image loss areas and redraws the image loss area display frame line 1403 to update the print preview screen 1401.

Return to the description of FIG. 13. Steps S1312 to S1315 of FIG. 13 represent the sequence where the user changes the borderless bleed amounts using the control 1404 on the print preview screen 1401 illustrated in FIG. 14A. In step S1312, the user changes the borderless bleed amounts. In the present embodiment, the user changes the borderless bleed amounts from "large bleed amount" to "medium bleed amount".

In step S1313, the print data editing unit UI display unit 209 updates the setting values of the borderless bleed amounts in the PT based on the selection of "medium bleed amount" by the user.

In step S1314, the print data editing unit UI display unit 209 recalculates the image loss areas based on the borderless bleed amounts corresponding to the changed bleed amount setting. After the recalculation of the image loss areas, the print data editing unit UI display unit 209 redraws the image loss area display frame line 1403 and generates the print preview screen again. In step S1315, the print data editing unit UI display unit 209 updates the print preview screen.

FIG. 14B illustrates a print preview screen 1405 that is updated by the print data editing unit UI display unit 209 recalculating the image loss areas and redrawing the image loss area display frame line. An image loss area display frame line 1406 on the print preview screen 1405 is the frame line redrawn by the print data editing unit UI display unit 209 when the user changes the setting values of the borderless bleed amounts to "medium bleed amount" via the control 1404.

A comparison between the print preview screens 1401 and 1405 shows that the image loss areas in the print preview screen 1405 are smaller due to the change of the borderless bleed amounts from "large bleed amount" to "medium bleed amount". The print preview screen 1405 also displays a control 1407 capable of selecting the borderless bleed amounts, with the selected value updated to "medium bleed amount".

After the print preview screen illustrated in FIG. 14B is displayed in step S1315 of FIG. 13, then in step S1316, the user selects whether to execute or cancel printing. The processing of steps S1316 to S1319 is similar to that of steps S713 to S716 described with reference to FIG. 7. A description thereof will thus be omitted.

In step S1319, the print data editing unit 208 is notified of the termination of the processing of the print data editing unit UI display unit 209. After the notification, in step S1320, the print data editing unit 208 requests the print execution flag stored in the shared information 210 by the print data editing unit UI display unit 209 from the shared information 210. In step S1321, the print data editing unit 208 acquires the print execution flag.

With the print execution flag acquired in step S1321, the print data editing unit 208 determines whether to execute or cancel printing. The present embodiment will be described on the assumption that printing is to be executed.

Upon determining to execute printing based on the content of the print execution flag, then in step S1322, the print data editing unit 208 generates a print job for executing printing. In step S1323, the print data editing unit 208 transmits the print job to the printing apparatus 102. The print job includes the image data for the printing apparatus 102 to print and information about the print attribute values for performing IPP printing. In the present embodiment, the print data editing unit 208 transmits the setting values related to the borderless bleed amounts selected by the user as information included in the print attribute values.

The printing apparatus 102 receives the print job transmitted from the host computer 101. In a case where the print attribute values included in the received print job include attributes related to the borderless bleed amounts, the printing apparatus 102 enlarges images based on the borderless bleed amounts set by the print attribute values and performs borderless printing.

The above is an example where the extension application 204 changes the setting values by acquiring the settable values of the borderless bleed amounts from the printing apparatus 102 and adding the settable values to the PDC. The example also covers the case where the print data editing unit UI display unit 209 provides a print preview display based on the selected setting values of the borderless bleed amounts.

In this example, the borderless bleed amounts are changed using a control provided by the print data editing unit UI display unit 209. This enables checking the print result based on the changed bleed amounts, and printing can be performed by changing the borderless bleed amounts while checking the outcome in the print preview. This can reduce the possibility of misprints from the user's perspective, and usability can be expected to improve since there is no need to launch the print setting screen again for setting changes.

Such an example is not restrictive, and the setting values of the borderless bleed amounts may be changeable using the controls provided by the print setting screen 510. Alternatively, the setting values of the borderless bleed amounts may be changeable using only the controls provided by the print data editing unit UI display unit 209, without providing controls for changing the setting values of the borderless bleed amounts on the print setting screen 510.

As described above, according to the foregoing embodiments, the user can check the image loss areas to appear due to image enlargement by the printing apparatus 102 on a print preview screen in performing borderless printing using the OS standard printing and the extension application 204.

The provision of the method for changing the setting values of borderless printing on a print preview screen enables selecting the borderless bleed amounts while observing the print preview. Users can thereby select the outcome they expect more easily, and the utility of the OS standard printing and the extension application 204 for users improves.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-197637, filed November 12, 2024, which is hereby incorporated by reference herein in its entirety.

What is claimed is:

1. A non-transitory computer-readable storage medium storing an application program which causes an information processing apparatus to perform a control method, the application program cooperating with an Internet Printing Protocol (IPP) class driver, the control method comprising:
displaying, as first displaying, a first object capable of setting a setting value relating to borderless printing; and
displaying, as second displaying, in a case where borderless printing is set to be performed by using the first object, an image indicating data to be printed and information for indicating a range, within the data to be printed, that is to be printed on a sheet by performing borderless printing.

2. The non-transitory computer-readable storage medium according to claim 1, wherein the second displaying is displaying the range, within the data to be printed, that is to be printed on the sheet by performing borderless printing and a range, within the data to be printed, that exceeds the sheet when borderless printing is performed.

3. The non-transitory computer-readable storage medium according to claim 1,
wherein the information for indicating the range that is to be printed on the sheet is an image of a frame line, and
wherein, in the second displaying, the image of the frame line is superimposed on the image indicating the data to be printed.

4. The non-transitory computer-readable storage medium according to claim 1, wherein the image indicating the data to be printed is an image generated by an operating system of the information processing apparatus.

5. The non-transitory computer-readable storage medium according to claim 4, wherein the image generated by the operating system of the information processing apparatus is intermediate data.

6. The non-transitory computer-readable storage medium according to claim 4, wherein the image generated by the operating system of the information processing apparatus is data in Extensible Markup Language (XML) Paper Specification (XPS) format.

7. The non-transitory computer-readable storage medium according to claim 1, wherein the information for indicating the range that is to be printed on the sheet is displayed based on information about a margin of the sheet.

8. The non-transitory computer-readable storage medium according to claim 1, wherein the information about a margin of the sheet is downloaded to the information processing apparatus along with the application program.

9. The non-transitory computer-readable storage medium according to claim 1, the control method further comprising performing acquiring by causing the information processing apparatus acquire information about a margin of the sheet from a printer selected as a transmission destination of print data.

10. The non-transitory computer-readable storage medium according to claim 9, wherein the acquiring is performed in accordance with IPP.

11. The non-transitory computer-readable storage medium according to claim 1, the control method further comprising:
displaying, as third displaying, by causing the information processing apparatus to display a second object capable of setting a setting value relating to information about a margin of the sheet,
wherein the information about the margin of the sheet is determined based on the setting value that has been set using the second object.

12. The non-transitory computer-readable storage medium according to claim 11, wherein in response to borderless printing being set to be performed using the first object, the information processing apparatus is caused to perform the third displaying.

13. The non-transitory computer-readable storage medium according to claim 1, the control method further comprising performing displaying, as fourth displaying, by causing the information processing apparatus to display a third object capable of setting to perform printing by rotating the image indicating the data to be printed by 180 degrees (º).

14. A control method of an information processing apparatus, in which an Internet Printing Protocol (IPP) Class Driver and an application program are installed, the application program cooperating with the IPP Class Driver, the control method comprising:
displaying, as first displaying, a first object capable of setting a setting value relating to borderless printing; and
displaying, as second displaying, in a case where borderless printing is set to be performed by using the first object, an image indicating data to be printed and information for indicating a range, within the data to be printed, that is to be printed on a sheet by performing borderless printing.

15. An information processing apparatus, in which an Internet Printing Protocol (IPP) Class Driver and an application program are installed, the application program cooperating with the IPP Class Driver, the information processing apparatus comprising
at least one processor operating to:
execute the application program to
display, as first displaying, a first object capable of setting a setting value relating to borderless printing; and
display, as second displaying, in a case where borderless printing is set to be performed by using the first object, an image indicating data to be printed and information for indicating a range, within the data to be printed, that is to be printed on a sheet by performing borderless printing.
